(19) United States
(12) Patent Application Publication
(10) Pub. No.: US 2017/0246798 A1
(43) Pub. Date: Aug. 31, 2017

(54) SYSTEM AND METHOD FOR MANUFACTURING COMPONENTS USING THREE-DIMENSIONAL PRINTING

(71) Applicant: The United States of America as represented by the Secretary of the Navy, Crane, IN (US)

(72) Inventor: Jack Lam, Rancho Cucamonga, CA (US)

(21) Appl. No.: 15/056,382

(22) Filed: Feb. 29, 2016

(51) Int. Cl. B29C 67/00; B33Y 30/00; B33Y 50/02; B33Y 10/00

(52) U.S. Cl. CPC B29C 67/0051; B29C 67/0088; B29C 67/0092; B33Y 10/00; B33Y 30/00; B33Y 50/02

(57) ABSTRACT

A system of manufacturing a plurality of components at a location in which the components are used includes a computing device having a software program configured to generate at least one data file for the components and a non-transient memory configured to store the data file. Additionally, the system includes a three-dimensional printing device electrically coupled to the computing device. The three-dimensional printing device is configured to receive the data file and form the components in at least one of an axial plane and a radial plane during a single operation of the printing device.

### STATEMENT REGARDING FEDERALLY SPONSORED RESEARCH OR DEVELOPMENT

The invention described herein includes contributions by one or more employees of the Department of the Navy made in performance of official duties and may be manufactured, used and licensed by or for the United States Government for any governmental purpose without payment of any royalties thereon. This invention (Navy Case 103,277) is assigned to the United States Government and is available for licensing for commercial purposes. Licensing and technical inquiries may be directed to the Office of Research and Technology Applications, Naval Surface Warfare Center Port Hueneme; telephone number: (805) 228-8485.

### FIELD OF THE DISCLOSURE

The present invention relates generally to manufacturing components using three-dimensional printing and, more particularly, to a method and system for in situ manufacturing of components using three-dimensional printing.

### BACKGROUND AND SUMMARY OF THE DISCLOSURE

Various components may utilize gaskets, hoses, or other polymeric components for sealing, wear, or other purposes. Components such as these may wear or break over time and, therefore, must be replaced. However, when these components are used on watercrafts, aircrafts, or in remote places, it may be difficult to access replacement components because it may be impractical to travel with or store a large quantity of these components in a particular location or to order and receive a replacement component or part.

For example, a large watercraft may utilize thousands of sealing components, such as o-rings, for various applications. Because these sealing components are periodically replaced due to wear, it may be impractical for a watercraft to store thousands of replacement sealing components. Additionally, if a new sealing component is needed for a specific component, ordering and shipping delays may add to the time and cost to receive a replacement sealing component, thereby potentially rendering a particular device or machine inoperable until the replacement component arrives.

Currently, wear and sealing components may be formed during a molding process, such as a compression molding process or an injection molding process. For example, in the compression molding process, a polymeric slug may be manually inserted into a mold or tool before the mold is closed around the slug. The mold applies pressure and/or heat to the polymeric slug such that the slug forms the desired shape of the mold. However, compression molding can be a time consuming process and best suited to the manufacture of small quantities of components and/or components with large dimensions.

Additionally, during an injection molding process, a polymeric slug is injected into the mold or tool which may have several cavities for forming at least one component. While injection molding may be suited to the manufacture of large quantities of components and/or components with smaller dimensions, injection molding is a complex technology requiring a specific molding apparatus and known pressure and temperature parameters. Additionally, injection molding techniques may result in production problems caused by defects in the molded component or defects which occur during the molding process.

Also, both compression and injection molding processes require large and expensive equipment and may produce large quantities of excess material which must be removed from the final molded component. Therefore, there is a need for a method, system, and/or apparatus which allows for the rapid manufacture of a variety of components (e.g., sealing and/or wear components) in situ.

In one illustrative embodiment of the present disclosure, a method of manufacturing a plurality of components at a location in which the components are used comprises providing a computing device including a software program configured to generate at least one data file for the components and a non-transient memory configured to store the data file. The method further comprises transmitting the data file to a three-dimensional printing device, and forming, with the three-dimensional printing device, the components in at least one of an axial plane and a radial plane during a single operation of the printing device.

In another illustrative embodiment of the present disclosure, a system of manufacturing a plurality of components at a location in which the components are used includes a computing device having a software program configured to generate at least one data file for the components and a non-transient memory configured to store the data file. Additionally, the system includes a three-dimensional printing device electrically coupled to the computing device. The three-dimensional printing device is configured to receive the data file and form the components in at least one of an axial plane and a radial plane during a single operation of the printing device.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a schematic view of an in situ manufacturing system for forming at least one component at the location in which the at least one component is used;

FIG. 1A is a schematic view of a three-dimensional printing device of the system of FIG. 1;

FIG. 2 is a top view of a first configuration of components positioned in the same radial plane after formation thereof using the manufacturing system of FIG. 1 with a support material positioned radially intermediate the radially-concentric components;

FIG. 3 is a side view of a second configuration of components positioned in the same axial plane after formation thereof using the manufacturing system of FIG. 1 with a support material positioned intermediate the axially-stacked components;

FIG. 4 is a side, cross-sectional view of a plurality of components, illustratively o-rings, positioned in the same axial plane and some components also positioned in the same radial plane, and the components are formed using the manufacturing system of FIG. 1, with a support material coupled to at least one of the components; and

FIG. 5 is a flow chart of a method of operating the system of FIG. 1 to form at least one component.

Corresponding reference characters indicate corresponding parts throughout the several views. Unless stated otherwise the drawings are proportional.

### DETAILED DESCRIPTION OF THE DRAWINGS

For the purposes of promoting an understanding of the principles of the present disclosure, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of the principles of the invention which would normally occur to one skilled in the art to which the invention relates.

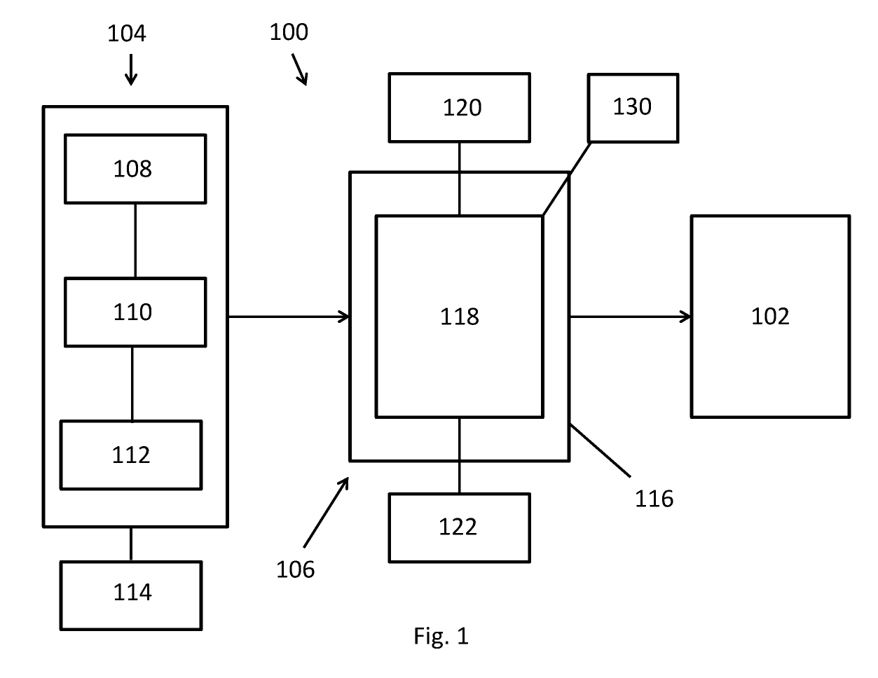

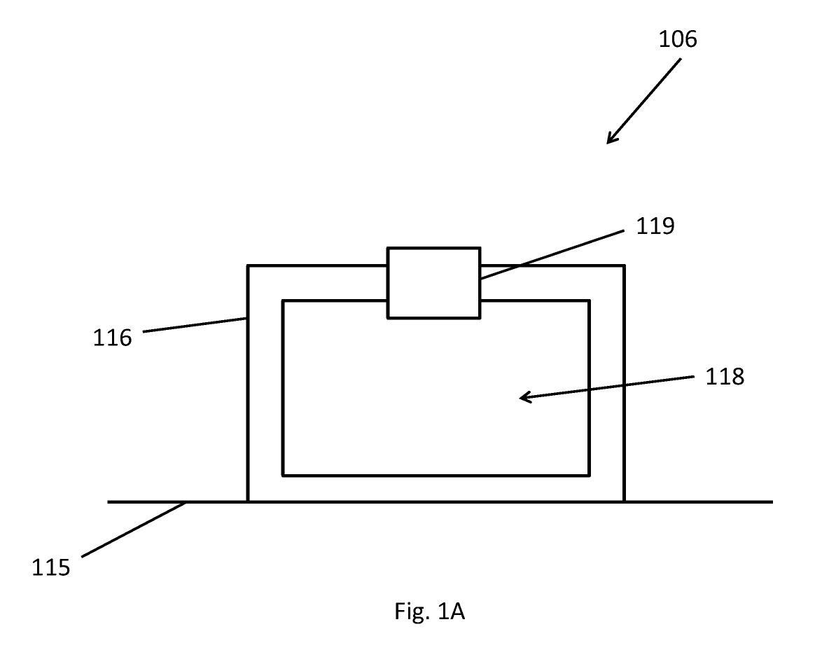

Referring to FIG. 1, a system 100 for manufacturing at least one component 102 includes a computing device 104 and a three-dimensional (“3D”) printing device 106. System 100 is configured to be used at the location in which components 102 are used. As such, system 100 is an in situ manufacturing system for rapidly forming components 102 in a single location. For example, system 100 may be implemented on a watercraft, an aircraft, and/or in a remote location where rapid access to components 102 may be necessary. In this way, system 100 may eliminate the need to travel with or store a large quantity of replacement components 102. Additionally, system 100 allows for new components 102 to be made if a new machine, device, or apparatus is constructed at that location.

In one embodiment, components 102 are flexible and bendable components configured for wear or sealing purposes, such as gaskets, o-rings, sleeves, bushings, and any other similar component. In a further embodiment, components 102 may be any other polymeric component configured for use at a specific location, such as hoses, footwear, apparel, valve components, components for pumps, engine components, or any other component.

Illustratively, component 102 is described as an o-ring, which is a packing or toric joint configured in the shape of a torus with a circular cross-section configured to be seated in a groove and compressed between two or more surfaces for sealing and/or wear purposes at the interface of the surfaces. For example, an o-ring maybe configured to form a seal at the interface capable of withstanding pressures on the order of megapascals (“MPa”).

Regardless of the specific configuration of component 102, component 102 is formed of a polymeric material, such an elastomeric material, to form a flexible and bendable component. In one embodiment, the elastomeric material for forming component 102 may be rubber-like material, such as polypropylene.

During use, component 102 may become worn or break and, therefore, may need to be replaced. However, component 102 may be used in a remote location or at a location in which it is not possible to store a large quantities of replacement components. Yet, ordering a replacement component 102 also may not be ideal because of order and shipping costs, the possibility of shipping delays, and the potential inaccessibility of the location of component 102. For example, if component 102 is used on a watercraft, it may be difficult to order and receive a component at the remote location of the watercraft. As such, system 100 is configured for in situ manufacturing of component 102 at the location in which component 102 is being used, which allows for rapid replacement of component 102 without the need to store replacement components.

Referring still to FIG. 1, to manufacture at least one replacement component 102, the parameters of component 102 must be known. System 100 is configured to output the parameters of component 102 through any of a plurality of operations. For example, in one embodiment, computing device 104 includes software 108, a memory 110, a database or library 112, and a controller (not shown). Memory 110 may be configured as a non-transient computer readable storage medium. The controller may be configured to control operation of software 108, memory 110, library 112, and/or printing device 106 and also may be configured to receive and output information between computing device 104 and printing device 106, as disclosed further herein. Functions of the controller may be performed by hardware and/or as computer instructions on memory 110.

Software 108 may be a three-dimensional graphic design software, such as AUTOCAD® or SOLIDWORKS®, configured to allow a user at the location of component 102 or a remote user to “draw” or otherwise generate a data file containing a 3D “sketch” and the parameters of component 102. In one embodiment, when component 102 is a circular seal, such as an o-ring, gasket, or bushing, the 3D “sketch” may be generated by first generating a two-dimensional sketch of component 102 and then creating a sweeping path with a 3D function over a single axis at a fixed distance. The data file also may contain parameters such as the dimensions (height, width, length, radius, inner diameter, outer diameter, surface area, volume, density, etc.) of component 102, the type and quantity of material comprising component 102, any manufacturing parameters for forming component 102, and any other data or information necessary to form component 102.

In another embodiment, software 108 is not used to generate a data file for component 102, but rather, computing device 104 may be electrically coupled (through wireless signals or electrical lines or connections) to an external database containing a plurality of data files for each individual component being used at the location that may need to be replaced. The database may be an external database and the data files therein may be uploaded to memory 110, for example through a USB or wireless connection. As such, memory 110 is configured to store a plurality of data files for any components at a specific location that may need to be replaced. Memory 108 also is configured to store any data files created by software 108. The controller may operate with software 108 and/or memory 110 to transmit the data file to printing device 106.

Alternatively, and as shown in FIG. 1, instead of obtaining a data file through software 108 or an external database as disclosed above, computing device 104 also may include an internal library or database 112 which contains a plurality of data files or information about each component 102 used at the location. For example, library 112 may include a plurality of data files generated at that location with software 108, may contain internal data files previously prepared “off site” and stored therein for each component 102, and/or may contain a parts or identification (“ID”) number list for each component 102 which allows a user to input only the part or ID number for component 102 into computing device 104 to obtain the necessary data file for component 102. In illustrative example of at least a portion of a parts list of library 112 is shown in Table 1, where the parameters disclosed in Table 1 may not be accurate for any particular component but represents potential data that may be contained within Library 112. Library 112 may transmit the data file for component 102 to memory 110 for transmission to computing device 106 through the controller or may directly transmit the data file to computing device 106 by way of the controller. While shown separately in FIG. 1, library 112 also may be contained within memory 110 of computing device 104.

TABLE 1
An Illustrative Example of a Parts List of Library 112

| | Inner Diameter | Outer Diameter | Density | |
|---|---|---|---|---|
| Part Number | (mm) | (mm) | (g/mL) | Material |
| 1001 | 10 | 13 | 1.2 | Polypropylene |
| 1002 | 50 | 55 | 2.5 | Polypropylene |
| 1003 | 100 | 107 | 3.2 | Rubber |

Additionally, as shown in FIG. 1, computing device 104 may be coupled to an external three-dimensional scanning device 114 or, alternatively, scanning device 114 may be included on computing device 104. Scanning device 114 is configured to receive component 102 needing replacement and form a three-dimensional scan of component 102 to determine the size, material, and/or other information about component 102. For example, scanning device 114 may be configured to scan, measure, or otherwise determine the parameters of component 102 along a plurality of different axes (e.g., six axes). With the parameters obtained through scanning device 114, a user and/or computing device 104 may be configured to determine or input the material for component 102. The information obtained by scanning device 114 may be transmitted to memory 110 and/or printing device 106 via the controller for forming a replacement component 102 matching the scanned component.

Referring still to FIGS. 1 and 1A, the parameters needed to form component 102 may be obtained through any of the above-disclosed processes and are transmitted to printing device 106 for the formation of component 102. Printing device 106 may include support platform 115, a housing 116 positioned on support platform 115, an operating or printing chamber 118 positioned within at least a portion of housing 116, and at least one print head 119 coupled to housing 116 and extending into printing chamber 118 to provide material for forming at least component 102. In one embodiment, printing device 106 may be a 3D printer, such as the Object260 Connex printer available from Stratasys, Inc. of Eden Prairie, Minn. The operation of a 3D printer may be disclosed in U.S. Pat. No. 6,722,872, the complete disclosure of which is expressly incorporated by reference herein.

In one embodiment, printing device 106 is operably coupled to or, alternatively, contains a first material supply 120 configured to supply a first material for forming component 102 to printing chamber 118. In one embodiment, the first material may be any polymeric material and, more particularly, may be an elastomeric material such as polypropylene. In one embodiment, first material supply 120 may contain multiple internal chambers for supplying more than one material to printing chamber 118, depending on the application and parameters of component 102. Printing device 106 is configured to form component 102, as shown in FIG. 1, at the location in which component 102 is being used. As such, the location of component 102 includes printing device 106 and computing device 104 for rapid replacement of component 102 to eliminate the need for ordering and shipping a replacement component 102 and/or the need for storing replacement components 102 at that location.

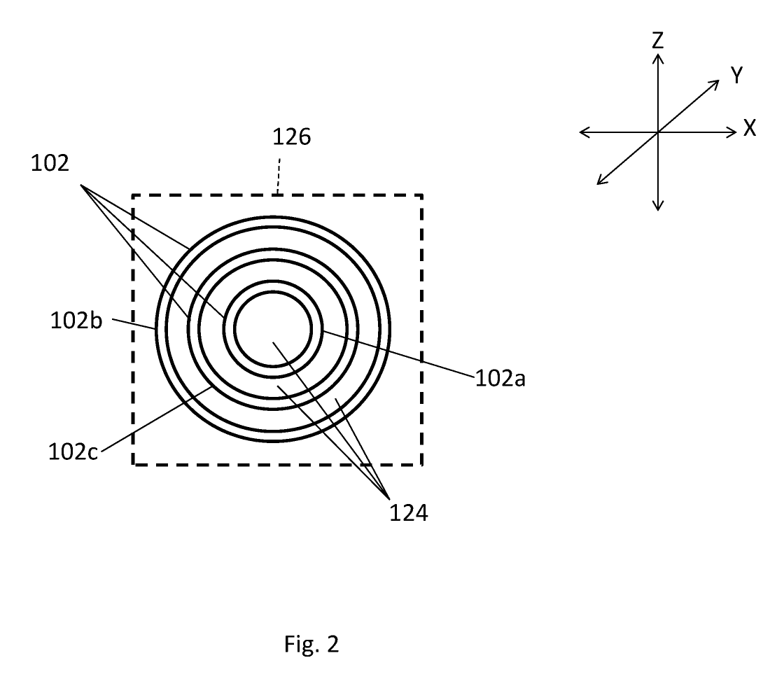

Additionally, printing device 106 may be operably coupled to or, alternatively, contain a second material supply 122 configured to supply a second material to printing chamber 118 for forming a support portion 124 (FIG. 2) which is at least partially in contact with component 102 during the formation process, as disclosed further herein. In one embodiment, second material supply 122 may contain multiple internal chambers for supplying more than one material for support portion 124. Alternatively, only one material supply may be provided such that first material supply 120 is configured to provide both the material comprising component 102 and the material comprising support portion 124. It may be appreciated that the second material is different from the first material and that any soluble material, such as a water-soluble material, may used for support portion 124, for example the soluble materials disclosed in U.S. Pat. No. 6,780,403, the complete disclosure of which is expressly incorporated by reference herein.

Referring still to FIG. 1, in one embodiment, a durometer 130 may be as part of printing device 106, may be separate from but operably coupled to printing device 130 and/or computing device 104, or may be independent from printing device 106 to measure the hardness of component 102 after component 102 is formed with printing device 102. For example, any hardness values determined by durometer 130 for component 102 may be compared to specifications (e.g., U.S. military standards or specifications (“MILSPEC”)) for the particular application of component 102. A user and/or computing device 104 may be used to compare the durometer measurement(s) to the specification for component 102.

As shown in FIGS. 2-4, printing device 106 is configured to form one or more components 102 during a single operation of printing device 106. By forming more than one component 102 during a single operation of printing device 102, system 100 increases the efficiency at which replacement or new components 102 may be formed. For example, as shown in FIG. 2, using o-rings as an example, a plurality of components 102 may formed in a concentric orientation. In this way, a plurality of components with different dimensions are formed about the same single axis, e.g., the Y-axis, which allows more than one type of replacement component 102 to be formed during a single operation of printing device 106. In one embodiment, an innermost component 102a has the smallest radius, an outermost component 102b has the largest radius, and any intermediate component 102c has a radius which is larger than that of component 102a but smaller than that of component 102b. Illustratively, three components 102 are shown but system 100 may be configured to form any number of components in a single operation of printing device 106. As shown in FIG. 2, this configuration arranges a plurality of components 102 in a single horizontal or radially-extending plane 126 which includes the X-axis.

Additionally, as shown in FIG. 2, a plurality of support portions 124 may be formed intermediate each component 102a, 102b, 102c. In one embodiment, support portions 124 may encapsulate at least a portion of each component 102. Support portions 124 contact at least a portion of two adjacent components to decrease the likelihood that the first material comprising components 102 adheres or otherwise couples with printing chamber 118 and also to maintain the shape of components 102 during the formation process. After components 102 are formed, support portions 124 may be dissolved or otherwise removed from components 102 with water or a chemical configured to remove support portions 124 without affecting components 102.

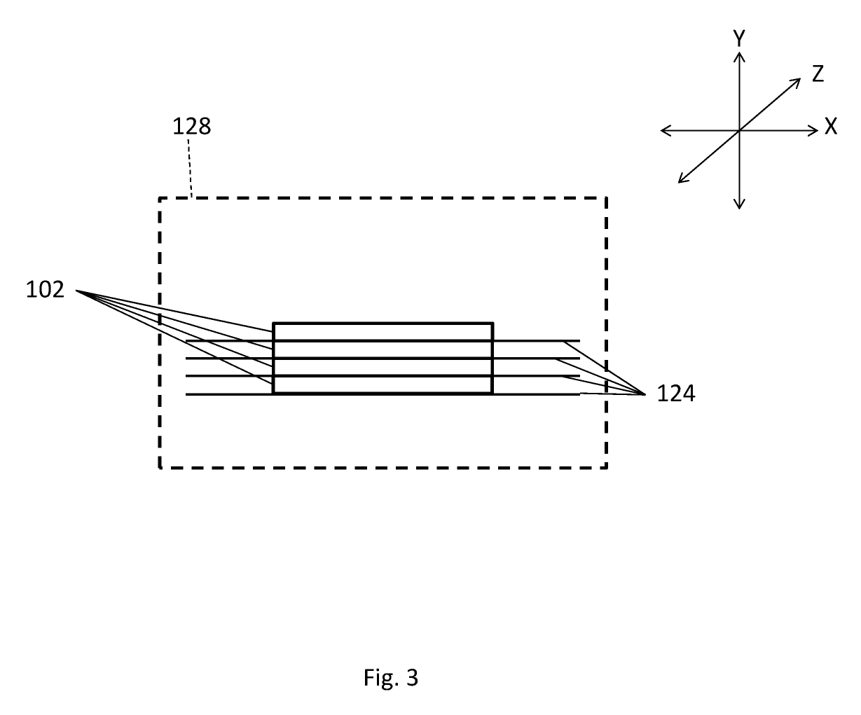

Referring to FIG. 3, printing device 106 also is configured to form a plurality of components 102 in the same axial plane during a single operation of printing device 106. More particularly, printing device 106 is configured to form components 102 in an axially-stacked arrangement such that components 102 are positioned within the same vertical plane 128 which includes the Y-axis. Illustratively, each component 102 has the same dimensions as other component 102 formed during this operation of printing device 106, however, printing device 106 is configured to form components 102 in an axially-stacked arrangement with different dimensions. In one embodiment, at least one components 102 may have dimensions disclosed in SAE AS568C which contains standard sizes for o-rings for particular applications.

Additionally, as shown in FIG. 3, a plurality of support portions 124 may be formed intermediate each component 102. In one embodiment, support portions 124 may encapsulate at least a portion of each component 102, however, illustratively, support portions 124 are shown as thin layers separating the axially-stacked components 102. In this way, support portions 124 separate each component 102 to prevent adjacent components 102 from adhering or otherwise coupling to each other during the formation process.

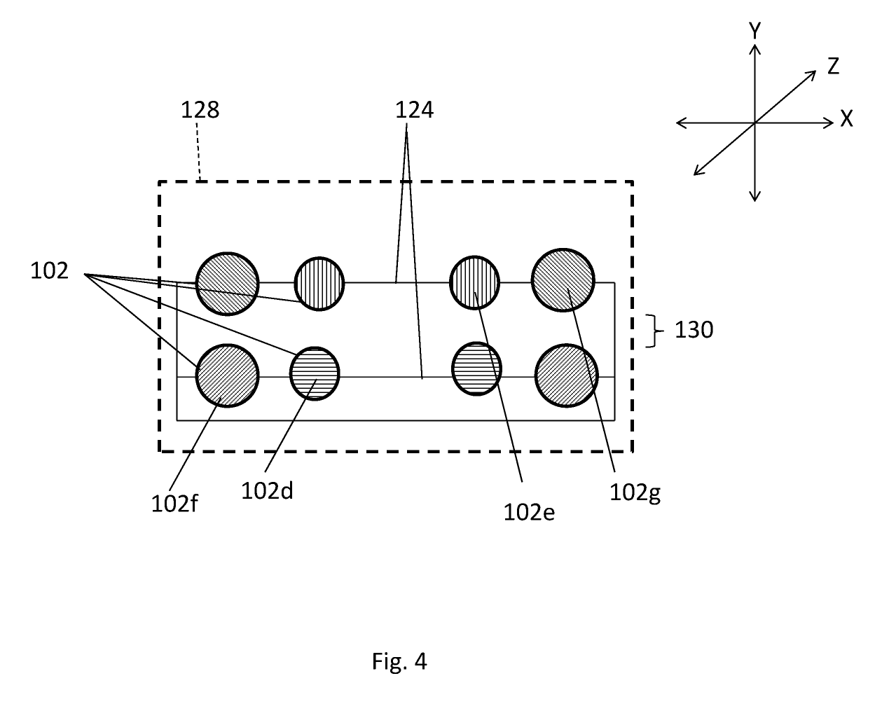

Referring to FIG. 4, printing device 106 also is configured to form some components, illustratively o-rings, in the same axial plane 128 and some components in the same radial plane 126 (FIG. 2). More particularly, printing device 106 is configured to form some components 102 in an axially-stacked arrangement such that components are formed in the same vertical plane 128 which includes the Y-axis. Additionally, during this single printing operation, printing device 106 also is configured to form components 102 in a concentric arrangement in which a plurality of components 102 are formed concentrically about the same axis and are positioned in the same horizontal plane 126 (FIG. 2) containing the X-axis. For example, a lower innermost component 102d is axially aligned with an upper innermost component 102e and is concentric with a lower outermost component 102f. Lower outermost component 102f also is axially aligned with an upper outermost component 102g which is concentric with upper innermost component 102e.

Additionally, as shown in FIG. 4, support portions 124 may be coupled to otherwise positioned around at a least a portion of components 102d, 102e, 102f, 102g. In one embodiment, lower components 102d, 102f may be fully encapsulated by support portions 124 while only a portion of upper components 102e, 102g may be in contact with support portions 124. In one embodiment, support portions 124 define a space or gap 130 between upper components 102e, 102g and lower components 102d, 102f to prevent material adherence between components 102d, 102e, 102f, 102g during formation of upper components 102e, 102g.

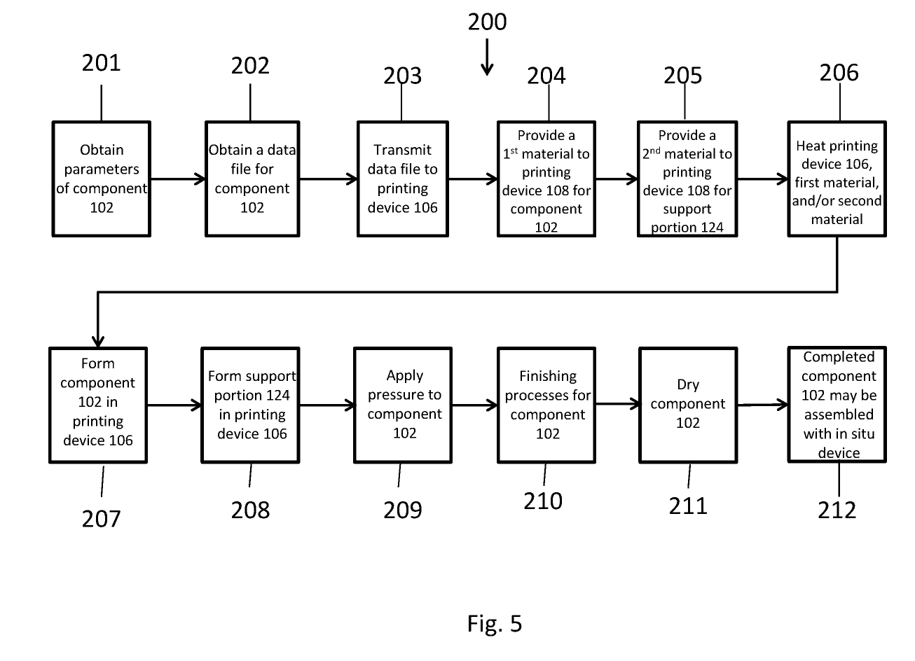

Referring to FIG. 5, system 100 operates according to a method 200, which includes Steps 201-212, to form component 102 (FIG. 1). In one embodiment, method 200 begins when a replacement or new component 102 is needed. The dimensions for component 102 are obtained in Step 201 through any of conventional measurement techniques (e.g., using a ruler, a scale, analytical equipment, or other measuring device), using software 108 to model component 102, identifying component 102 by its part or ID number in library 112, or from any other data stored in memory 110 (FIG. 1). Once the parameters for component 102 are identified in Step 201, if a data file has not been created for component 102, software 108 is used to generate a data file for component 102 in Step 202. Conversely, if a data file is already stored in memory 110 and/or library 112 for component 102, Step 202 may be skipped such that Step 201 proceeds directly to Step 203.

In Step 203, the data file for component 102 is transmitted to printing device 106 (FIG. 1) by the controller (not shown) from information obtained from software 108, memory 110, and/or library 112 of computing device 104. The data file provides printing device 106 with the necessary information for forming component 102, such as the dimensions and the type and quantity of material needed for component 102.

In Step 204, the material for component 102 is supplied to printing device 106 from first material supply 120 (FIG. 1). The material from first material supply 120 may be an elastomeric material provided to printing chamber 118 of printing device 106 in a liquid or powder form. In one embodiment, the material for component 102 flows from first material supply 120 to print head 119 of printing device 106 through fluid tubes or lines (not shown). Alternatively, the material for component 102 from first material supply 120 may be stored (e.g., in solid form) in a portion of print head 119 of printing device 106.

Either prior to, subsequent to, or simultaneous with Step 204, second material supply 122 may supply the material for support portion 124 to printing chamber 118. The material from second material supply 122 may be any soluble material provided to printing chamber 118 of printing device 106 in a liquid or powder form. In one embodiment, the material for support portion 124 flows from second material supply 122 to print head 119 of printing device 106 through fluid tubes or lines (not shown). Alternatively, the material for support portion 124 from second material supply 122 may be stored (e.g., in solid form) in a portion of print head 119 of printing device 106. However, if no support portion 124 is formed, then Step 205 may be eliminated such that Step 204 proceeds to Step 206.

Following Steps 204 and 205, the first and second materials from first and second material supplies 120, 122, respectively, may be heated by printing device 106. For example, if the materials are provided in powdered or another solid form, the materials may be heated to a melting point such that materials flow into printing chamber 118 to form the desired shape of component 102. In one embodiment, a heater (not shown) is included within printing device 106, for example in printing chamber 118, or is operably coupled to printing device 106 to increase the temperature of printing chamber 118, first material supply 120, and/or second material supply 122. The heater may be any heating device configured to increase temperature, for example a convention heater or an infrared heater. However, if it is not necessary to heat the first and second materials, then Step 206 may be skipped such that Step 204 proceeds to Step 207.

In Step 207, printing device 106 prints or otherwise forms component 102 from the polymeric material supplied by first material supply 120. In Step 207, printing device 106 forms the material from first material supply 120 into the desired shape of component 102. In one embodiment, the first material flows from print head 119 into printing chamber 118 to form component 102. The forming process may deposit the material in layers such that a plurality of layers of the first material form together to define component 102. Alternatively, the forming process may deposit larger quantities of material such that a continuous single deposit of material may form component 102. More particularly, printing device 106 may use any known 3D printing technique to form component 102.

Either prior to, subsequent to, or simultaneous with Step 207, the second material from second material supply 122 may be deposited through print head 119 into printing chamber 118 to form support portion 124 for supporting the formation of component 102, according to Step 208. In particular, print head 119 may deposit layers of the second material which together form support portion 124 or may deposit a larger quantity of the second material such that a continuous or single deposit of the second material may form support portion 124. However, if no support portion 124 is used during the formation of component 102, then Step 208 can be skipped such that Step 204 may proceed directly to Step 209.

In Step 209, pressured air or another pressurized fluid may be supplied to printing chamber 118 to apply pressure during the formation of component 102. The pressure supplied to printing chamber 118 during the formation of component 102 simulates a molding process which increases the density and strength of component 102. However, Step 209 is optional and, therefore, may be skipped.

In Step 210, method 200 may include a finishing process to finalize component 102. For example, Step 210 may include a smoothing process to smooth any rough edges or remove any excess material to complete the final shape and dimension of component 102. Step 210 may occur in printing chamber 118 or another portion of printing device 106 or, alternatively, component 102 may be removed from printing device 106 prior to Step 210 such that the process of Step 210 occurs outside of printing device 106. Step 210 may utilize any finishing or smoothing process, such as an air brushing technique, a liquid smoothing process, or any technique disclosed in U.S. Pat. No. 8,123,999, the complete disclosure of which is expressly incorporated by reference herein.

Additionally, Step 210 may include additional finishing steps such as removing the soluble material of support portions 124 to provide separate components 102. For example, the soluble material can be mechanically removed, dissolved in water, or chemically removed such that only separated components 102 remain. In one embodiment, component 102 is put into a water or chemical bath or sprayed with water or a chemical to remove support portion 124.

Also, Step 210 may include another finishing step, such as a hardness test performed by durometer 130 (FIG. 1) to ensure that the hardness of component(s) 102 meet any specifications required of component 102 for a particular application.

Following Step 210, component 102 may undergo a drying process in Step 211. For example, Step 211 may use a heater, a drying chamber, or ambient air to dry any liquid from the surface of component 102. Furthermore, Step 211 may be used to complete any curing process for the material comprising component 102.

Method 200 ends at Step 212 with a manufactured component 102 and is ready for assembly with any other part, machine, device, or apparatus at the location. As such, method 200 allows for components 102 to be formed at the location in which components 102 are used.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of manufacturing a plurality of components at a location in which the plurality of components are used, the method comprising:
providing a computing device including a software program configured to generate at least one data file for the plurality of components and a non-transient memory configured to store the data file;
transmitting the data file to a three-dimensional printing device;
forming, with the three-dimensional printing device, the plurality of components in at least one of an axial plane and a radial plane during a single operation of the printing device.

2. The method of claim 1, further comprising forming, with the three-dimensional printing device, a support portion comprised of a soluble material, and contacting at least a portion of one of the components with at least a portion of the support portion.

3. The method of claim 2, further comprising dissolving the support portion from the components.

4. The method of claim 2, wherein forming the components includes forming the components of a material different than the soluble material of the support portion.

5. The method of claim 1, further comprising forming the components in a single radial plane, the components being concentric with each other, and forming the support portion radially intermediate two of the components.

6. The method of claim 5, further comprising forming the components in a single vertical plane, the components being axially aligned in the single vertical plane, and forming the support portion axially intermediate two of the axially-aligned components.

7. The method of claim 6, wherein the support portion contacts at least two axially-adjacent components.

8. The method of claim 1, further comprising applying pressure to the components during the step of forming the components.

9. The method of claim 1, further comprising storing in the memory a first plurality of data files generated by the software program and storing in the memory a second plurality of data files based on an identification of each of the components.

10. The method of claim 1, further comprising generating a three-dimension scan of at least one of the components and generating the data file from the three-dimensional scan.

11. A system of manufacturing a plurality of components at a location in which the plurality of components are used, the system comprising:
a computing device including a software program configured to generate at least one data file for the plurality of components and a non-transient memory configured to store the data file; and
a three-dimensional printing device electrically coupled to the computing device, the three-dimensional printing device being configured to receive the data file and form the plurality of components in at least one of an axial plane and a radial plane during a single operation of the printing device.

12. The system of claim 11, wherein the three-dimensional printing device is configured to form a support portion from a soluble material.

13. The system of claim 12, wherein the support portion is coupled to at least some of the components and is configured to dissolve from the components.

14. The system of claim 12, wherein the components are comprised of a material different than the soluble material of the support portion.

15. The system of claim 11, wherein the three-dimensional printing device is configured to form the components in a single radial plane, the components being concentric with each other, and is configured to form the support portion radially intermediate two of the components.

16. The system of claim 15, wherein the three-dimensional printing device is configured to form the components in a single vertical plane, the components being axially aligned in the single vertical plane, and is configured to form the support portion axially intermediate two of the axially-aligned components.

17. The system of claim 16, wherein the support portion contacts each of the two axially-aligned components.

18. The system of claim 11, wherein the three-dimensional printing device is configured to apply pressure to the components.

19. The system of claim 11, wherein the non-transient memory is configured to store a first plurality of data files generated by the software program and a second plurality of data files based on an identification of each of the components.

20. The system of claim 11, wherein the computing device includes a three-dimensional scanner configured to form a three-dimension scan of at least one of the components and generate the data file from the three-dimensional scan.

21. A system of manufacturing a plurality of components at a location in which the plurality of components are used, the system comprising:
a computing device including a software program configured to generate at least one data file for the plurality of components and a non-transient memory configured to store the data file in a database; and
a three-dimensional printing device electrically coupled to the computing device, the three-dimensional printing device including a support platform, a housing supported on the support platform, a printing chamber contained within the housing, and a print head coupled to the housing, and the printing device being configured to receive the data file and form the plurality of components in both an axial plane and a radial plane during a single operation of the printing device, and the printing device being configured to form at least one support portion comprised of a soluble material between adjacent components of the plurality of components.

22. A method of manufacturing a plurality of components at a location in which the plurality of components are used, the method comprising:
providing a computing device including a software program and a non-transient memory configured to store a data file in at least one database;
generating the at least one data file for the plurality of components with at least one of the software program or an identification for the plurality of components;
transmitting the at least one data file to a three-dimensional printing device;
forming, with the three-dimensional printing device, the plurality of components in both an axial plane and a radial plane during a single operation of the printing device;
forming, with the three-dimensional printing device, a support portion comprised of a soluble material between adjacent components of the plurality of components;
applying pressure to the plurality of components;
removing the support portion from the adjacent components; and
drying the plurality of components.
